(19) United States
(12) Patent Application Publication
(10) Pub. No.: US 2013/0151341 A1
(43) Pub. Date: Jun. 13, 2013

(54) METHODS AND SYSTEMS FOR SENDING INTERACTIVE PROMOTION INFORMATION AND RECORDING MEDIUMS USING THE SAME

(71) Applicants: Chang-Yi KAO, Taipei (TW); Bing-Hui LU, New Taipei City (TW)

(72) Inventors: Chang-Yi KAO, Taipei (TW); Bing-Hui LU, New Taipei City (TW)

(73) Assignee: INSTITUTE FOR INFORMATION INDUSTRY, Taipei (TW)

(21) Appl. No.: 13/529,302

(22) Filed: Jun. 21, 2012

(30) Foreign Application Priority Data
Dec. 12, 2011 (TW) 100145728

(51) Int. Cl. G06Q 30/02

(52) U.S. Cl. 705/14.64

(57) ABSTRACT

Methods for sending interactive promotion information used between a portable device and a multimedia device are provided. The multimedia device stores a plurality of multimedia information and corresponding promotion information. The portable device is connected to the multimedia device of a specific place through a communication network. The portable device obtains a first certificate corresponding to a product of the specific place, wherein the first certificate includes consumer behavior information of the product and connection information for the multimedia device. The portable device logs into the multimedia device through the first certificate and the communication network. After successfully logging into the multimedia device, the portable device generates an operation user interface for operating the multimedia device to select one of the multimedia information to play. After the selected multimedia information has been completely played, the multimedia device transmits promotion information corresponding to the selected multimedia information to the portable device.

### CROSS REFERENCE TO RELATED APPLICATIONS

This Application claims priority of Taiwan Application No. 100145728, filed on Dec. 12, 2011, and the entirety of which is incorporated by reference herein.

### BACKGROUND OF THE INVENTION

1. Field of the Invention

The disclosure relates generally to interactive data systems and methods for sending interactive promotion information using the same, and, more particularly to interactive data systems and methods for sending interactive promotion information using the same capable of providing interaction operation between portable devices and multimedia devices in specific places.

2. Description of the Related Art

In order to increase the number of consumers, merchants usually offer shopping discounts, such as issuing coupons to consumers such that the consumers may come for shopping. In the early days, merchants announce the discount activities by newspapers and magazines or promotion flyers, and the consumers may collect printed coupon of intended buying products, further carry the coupon to the shop for buying, and then obtain the coupon discount. Recently, with widespread of digitalization and networks, printed coupons is replaced by electronic coupons, and merchants at specific places, such as restaurants, convenience stores and so on, will set up a multimedia device like information system KIOSK, advertisement broadcasting device, interactive device (interactive panel), to provide various discount coupon, so that the consumers may acquire electronic coupons through interactive operation with such machines, and then both merchants and consumers can be benefited from each other. In addition, such multimedia device can also broadcast some specific commodity advertisement for product promotion and also increase the intension of the consumers for shopping.

However, because a touch screen or other operation user interface, such as keyboard, remote controller and so on, may be provided to the multimedia devices (or other interactive panels) configured in stores, the convenience of user operation needs to be considered for the way of device configuration. Since it is not easy for some users to learn the operation user interface, the intension of the users for using such operation user interface may be reduced. In addition, advertisements in such multimedia device maybe displayed in various ways, such as being displayed on a fixed advertisement screen, being displayed on a signboard, being displayed in a pop-in screen or being displayed in a rotation, but users usually inattentively brows the above-mentioned advertisements. Because users may not freely choose self-interested advertisement to play, thereby users' free time in the store may not be effectively used for promotion, so that the in-store advertisement may only have little effect on promotion. Moreover, the use of prior model coupon, except attracting customers to come for shopping, no other information can be provided so that wish lists of consumers may not be obtained and effective forecasting and analysis for sales practices and inventory control can not be performed, and thus no further substantial benefit can be provided for the merchant.

### BRIEF SUMMARY OF THE INVENTION

Methods for sending interactive promotion information used between a portable device and a multimedia device and systems for sending interactive promotion information are provided.

In an embodiment, a method for sending interactive promotion information used between a portable device and a multimedia device is provided, wherein the multimedia device is set in a specific place and stores a plurality of multimedia information and promotion information corresponding thereto, and the portable device is connected to the multimedia device through a communication network. The method comprising the steps of the portable device obtaining a first certificate corresponding to a product of the specific place, wherein the first certificate at least comprises consumer behavior information of the product and connection information for the multimedia device; the portable device logging into the multimedia device through the first certificate and the communication network; the portable device generating an operation user interface for operating the multimedia device to select one of the multimedia information to play after successfully logging into the multimedia device; and after completion of playing the selected multimedia information, the multimedia device transmitting one of the promotion information corresponding to the selected multimedia information to the portable device.

Another embodiment of a system for sending interactive promotion information comprises a multimedia device and a portable device. The multimedia device is configured in a specific place for storing a plurality of multimedia information and promotion information corresponding thereto. The portable device is connected to the multimedia device through a communication network, wherein the portable device obtains a first certificate corresponding to a product of the specific place, wherein the first certificate at least comprises consumer behavior information of the product and connection information for the multimedia device of the specific place to provide the portable device to log into the multimedia device through the communication network, and the portable device further generates an operation user interface for operating the multimedia device to select one of the multimedia information to play after successfully logging into the multimedia device. Wherein, the multimedia device further transmits one of the promotion information corresponding to the selected multimedia information to the portable device after completion of playing the selected multimedia information.

Methods for sending interactive promotion information thereof may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1A is a schematic diagram illustrating a first embodiment of a system for sending interactive promotion information of the invention;

FIG. 1B is a schematic diagram illustrating a second embodiment of detail blocks of a system for sending interactive promotion information of the invention;

FIG. 2 is a flowchart of an embodiment of a method for sending interactive promotion information of the invention;

FIG. 3 is a flowchart of another embodiment of a method for sending interactive promotion information of the invention for performing a connection detection and determining which kind of communication network is used for connection;

FIG. 4 is a flowchart of another embodiment of an operation flow for an application of the portable device of the invention; and

FIG. 5 is a flowchart of another embodiment of an operation flow for a method for sending interactive promotion information of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Embodiments of systems and methods for sending interactive promotion information of the invention provide novel operation mode for multimedia devices (e.g. KIOSKs, interactive panels, advertisement devices) configured on specific places, such as restaurants or convenience stores. In the Embodiments, portable devices of users (such as smart phones, tablet computers, PDAs, mini-notebooks and notebooks) can be utilized as operation user interfaces to operate with the multimedia devices within the specific places. Then the users may convenience use their portable devices to operate the multimedia device and obtain corresponding coupons.

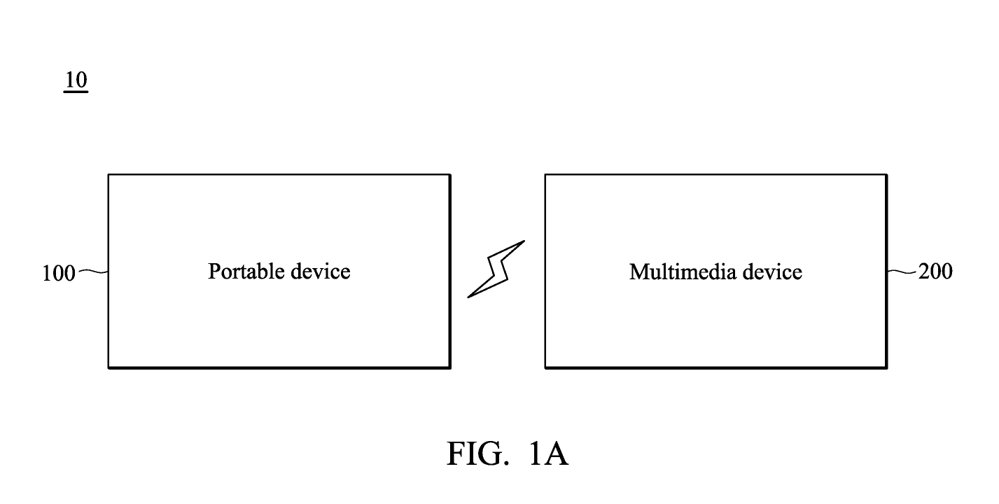

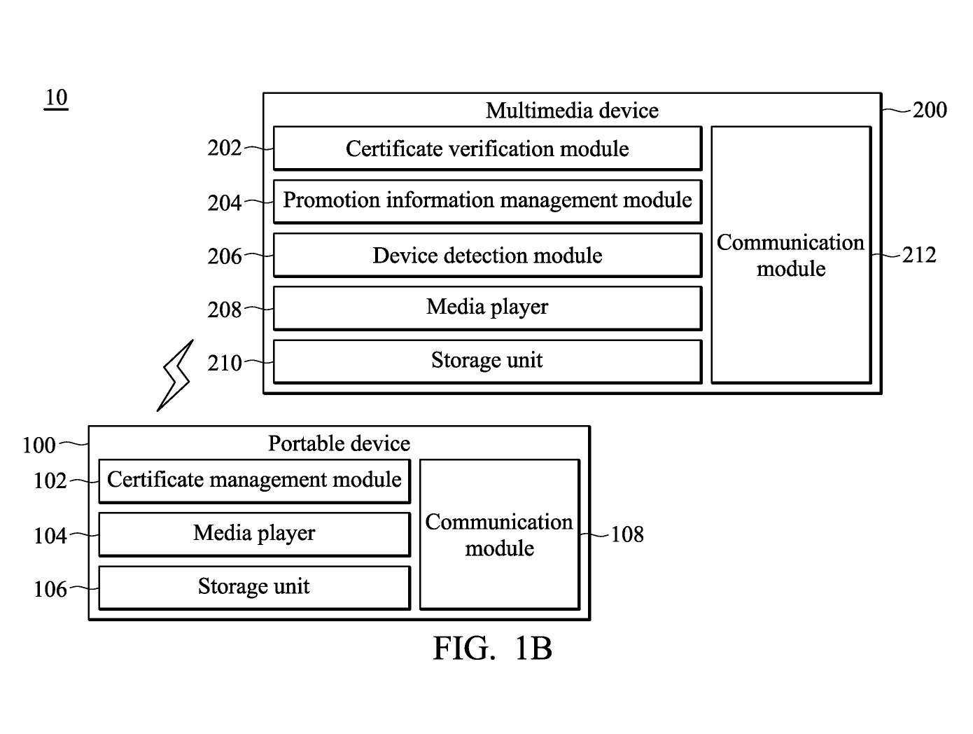

FIG. 1A is a schematic diagram illustrating a first embodiment of a system for sending interactive promotion information of the invention. The system for sending interactive promotion information 10 comprises a portable device 100 and a multimedia device 200, wherein the multimedia device 200 is set in a specific place and stores a plurality of multimedia information and promotion information corresponding thereto. The portable device 100 is connected to the multimedia device 200 through a communication network. For example, the portable device 100 may be notebooks, smart phones, tablet computes and so on, but the invention is not limited thereto. The multimedia device 200 is set in a specific place and stores a plurality of multimedia information provided by the advertisers, multimedia providers or other content providers and promotion information corresponding to the content of the multimedia information. The specific place may be, for example, a business premise, e.g. a restaurant, a convenience store, a market or other stores. The multimedia device 200 may be a machine configured in a specific position within the business premise, such as an interactive panel, an information system KIOSK, a multimedia advertisement device and so on. The promotion information corresponding to the content of the multimedia information may be a coupon, an e-coupon, a product exchange ticket, a bonus and loyalty points and so on. The consumer may utilize this coupon to buy products with a better price or obtain other preferences. In some embodiments, the multimedia device 200 may be at least one of a display, a television (TV), a multimedia information station, a TV wall and an outdoor advertisement panel, but it is not limited thereto. The multimedia device 200 may comprise connection information containing information about, for example, a device identification (ID) code, an IP address and a MAC address corresponding to the multimedia device 200. With this connection information, the portable device 100 may obtain the position of the multimedia device 200 and connect to the multimedia device 200. The communication network may be WIFI, Bluetooth, 3G or other types of connections, but it is not limited thereto. For example, the portable device 100 may connect to the multimedia device 200 through a WIFI connection.

The portable device 100 may obtain a first certificate corresponding to a product of the specific place, wherein the first certificate at least includes consumer behavior information of the product and connection information corresponding to the multimedia device 200 in the specific place. The first certificate can be used for the portable device 100 logging into the multimedia device 200 via the communication network. After successfully logging into the multimedia device 200, the portable device 100 may generate an operation for operating the multimedia device 200 to select one of the multimedia information for playing. The multimedia device 200 may then transmit promotion information responsive to the played multimedia information to the portable device 100 after the playing of the selected multimedia information is completed.

FIG. 1B is a schematic diagram illustrating a second embodiment of detail blocks of a system for sending interactive promotion information 10 of the invention. As shown in FIG. 1B, the system for sending interactive promotion information 10 at least comprises the portable device 100 and the multimedia device 200, and the portable device 100 may connect with the multimedia device 200 through a communication network. The portable device 100 may further comprise a certificate management module 102, a media player 104, a storage unit 106 and a communication module 108. The certificate management module 102 may read the first certificate, such as a QR code or electronic information certificate, analyzes read certificate and generates an authentication information for logging into the multimedia device 200 according to the consumer behavior information contained in the read certificate and user information in the portable device 100. Then the certificate management module 102 communicates with the multimedia device 200 through this authentication information. The media player 104 may play advertisement medias with any kind of video/audio formats, wherein the media player 104 may further have the capability of playing video streaming for receiving and playing the video streaming data from the multimedia device 200. The storage unit 106 may store various required information, such as the user information, the consumer behavior information and so on.

The multimedia device 200 may further comprise a certificate verification module 202, a promotion information management module 204, a device detection module 206, a media player 208, a storage unit 210 and a communication module 212. The communication module 212 and the communication module 108 can be any type of communication modules, preferably to be a wireless communication module, such as a blue-tooth communication module, a WIFI, 3G or a WLAN communication module in compliance with IEEE 802.1X standards, for performing a connection detection procedure between the portable device 100 and the multimedia device 200 and establishing a communication network connection accordingly so as to perform data transmission therebetween. The certificate verification module 202 may receive the certificate information transmitted by the portable device 100 via the communication module 212 and analyze the certificate information to obtain the consumer behavior information and the user information to determine whether the portable device 100 can successfully log into the multimedia device 200. The promotion information management module 204 may determine a set of selectable multimedia information from the storage unit 210 according to the consumer behavior information and the user information decoded by the certificate verification module 202 and a media type (e.g. a media tag) of the multimedia information selected by the portable device 100. The promotion information management module 204 also determine whether the playing of the multimedia information has been completed so as to transmit the promotion information responsive to the played multimedia information to the portable device 100 via the communication module 212 after the playing of the multimedia information has been completed. The device detection module 206 may detect whether the portable device 100 is an authorized user, wherein the first certificate may further comprise positioning information corresponding to the portable device 100 to determine whether the portable device 100 is located nearby the specific place of the multimedia device 200 within a predetermined range. The portable device 100 is only allowed to log to the multimedia device 200 when the device detection module 206 determines that the portable device is really located nearby the specific place of the multimedia device 200 within the predetermined range. By doing so, login requests for logging into the multimedia device 200 from other portable devices that are not located nearby the specific place of the multimedia device 200 within the predetermined range can be avoided. The media player 208 may obtain responsive multimedia information from the storage unit 210 in response to a selection signal to play it directly or transmit the responsive multimedia information in a video streaming transmission way to the portable device 100. The storage unit 210 may store a number of multimedia information provided by multiple advertisers (or multimedia providers or other content providers) and promotion information corresponding to the content of the multimedia information (e.g. the coupon) and may also store the consumer behavior information and the personal information analyzed by the certificate verification module 202 and related user information. The responsive method for sending interactive promotion information will be discussed further in the following paragraphs.

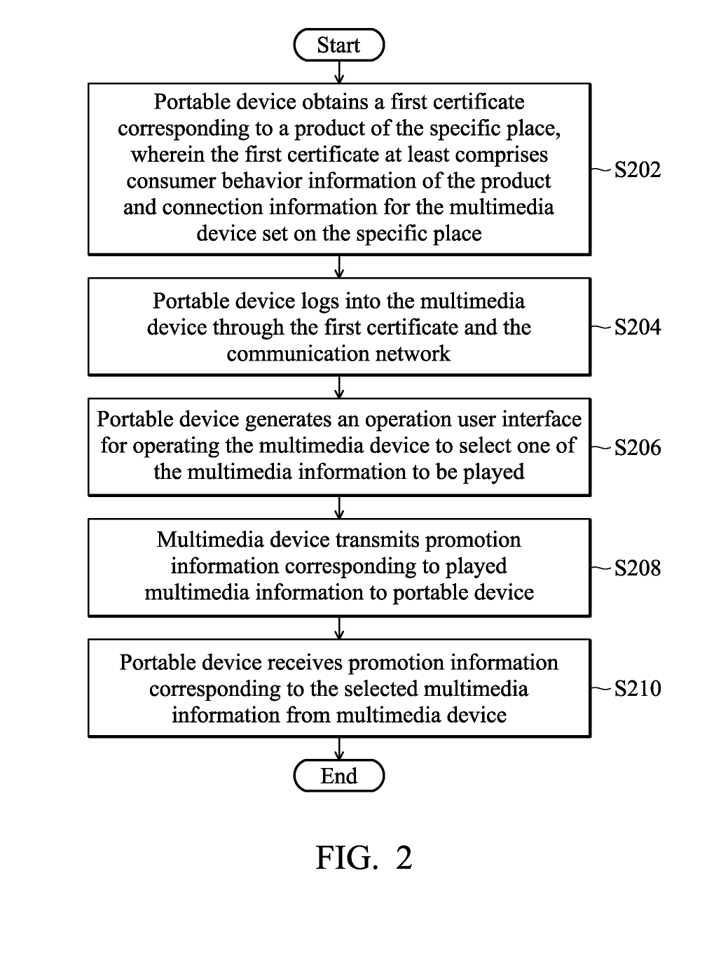

FIG. 2 is a flowchart of an embodiment of a method for sending interactive promotion information of the invention. Please refer together to FIGS. 1A, 1B and 2. The method for sending interactive promotion information of the invention can be applied between the portable device 100 and the multimedia device 200, wherein the multimedia device 200 is set in a specific place and stores a plurality of multimedia information and promotion information corresponding to the multimedia information. The portable device 100 may be connected to the multimedia device 200 via a communication network.

In step S202, the portable device 100 obtains a first certificate corresponding to a product of the specific place. The portable device 100 may obtain the first certificate corresponding to a product of the specific place via the certificate management module 102. The first certificate at least comprises consumer behavior information of the product and connection information for the multimedia device 200 for providing the portable device 100 to log into the multimedia device 200 through the communication network, which at least comprises information regarding device ID and its IP address, user consumption information, such as name, amount, amount of money and so on of bought product, consumption certificate code, e.g. PID, and GPS positioning signal and so on. In some embodiments, when the first certificate is a paper QR code, the user may capture the paper QR code by an image capturing device (e,g, a camera or a video recorder) and analysis the QR code by using an application (APP) with an QR code analysis function to obtain information included in the certificate image on the purchasing receipt, e.g. the consumer behavior information and the connection information, In other embodiments, after buying some products at the specific place, the user may use their portable device 100 to receive the first certificate with electronic information from cashier systems, POS systems or accounting systems and then obtain the information include in the first certificate.

After obtaining the first certificate, in step S204, the portable device 100 logs into the multimedia device 200 through the first certificate and the communication network. In this step, the portable device 100 may connect with the multimedia device 200 based on the connection information of the first certificate, Further, to make the multimedia information met to the user requirement, the certificate management module 102 generates authentication information according to the consumer behavior information contained in the first certificate and a user information corresponding to the portable device 100. The user information may include personal information such as gender, age, education, profession and so on. The user information may be predefined by the user and stored in the storage unit 106 or the personal information may be inputted via an input interface of the APP. To be more specific, the certificate management module 102 may analyze the consumer behavior information of the certificate and integrate it with the user information to generate a new certificate as the authentication information. After the authentication information has been generated, the communication module 108 logs into the multimedia device 200 via a communication network according to the connection information and the authentication information. The communication module 108 logs into the multimedia device 200 via the communication network according to the connection information and the authentication information may be achieved by locating the position of the multimedia device 200 using information regarding the device ID, IP address, MAC address and so on within the connection information to confirm a connection mode of the communication network, establish a connection between the portable device 100 and the multimedia device 200, and then request to log into the multimedia device 200 using the authentication information. There are a number of connections provided between the portable device 100 and the multimedia device 200, such as WIFI, 3G or blue-tooth connection of wireless communications, and the communication module 108 of the portable device 100 may select one connection from the connections to establish the communication network with the multimedia device 200 according to a specific sequence. Establishment of the connection may be determined based on transmission attributes. For example, simple certificate transmission requires fast transmission to prevent users from waiting, and thus the communication module 108 checks the currently fastest connection, such as WIFI or blue-tooth of wireless communication networks. If no such type of communication network has been activated, other communication modules may be activated sequentially. In other embodiments, if multimedia data is to be transmitted, a large amount of data transmissions are required so that the communication module 108 may first establish the connection using the WIFI communication link and then establish the connection using the 3G communication link. If the connection established is not stable during performing a certificate verification or simple signal transmission, the communication module 108 may assist to switch to other connection to keep stability of the connection and restore the connection status after it is disconnected.

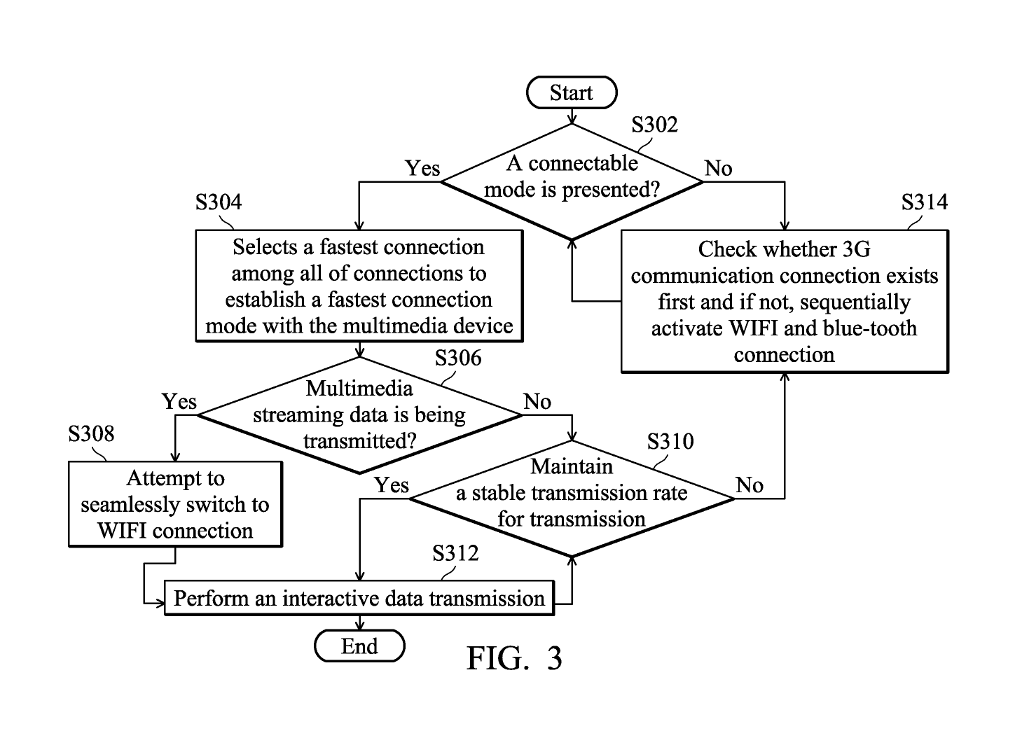

FIG. 3 is a flowchart of another embodiment of a method for sending interactive promotion information of the invention for performing connection detection and determining which kind of communication network way is used for connection. Please refer together to FIGS. 1B and 3. First, the communication module 108 checks whether a connectable mode is presented (step S302). The communication network may be wired or wireless communication network connections, e.g. wireless connection is adopted in this embodiment. If so, the communication module 108 selects a fastest connection link among all of the connections to establish a fastest connection mode with the multimedia device 200 (step S304). Thereafter, the communication module 108 checks whether the multimedia streaming is being transmitted (step S306). If so (Yes in step S306), the communication module 108 attempts to seamlessly switch from the current communication network to other connection, e.g. the WIFI connection (step S308) and starts to transmit interactive data (step S312). During the transmission of the interactive data, the communication module 108 will maintain a stable transmission rate for transmission (step S310), and then goes back to step S312 to repeatedly perform the interactive transmission. After the transmission of the interactive data is completed, the communication module 108 ends the flow and deactivates the originally activated transmission module. When it is found that non-multimedia streaming is being transmitted (No in step S306), the communication module 108 goes back to step S310 to determine whether the transmission is performed at a stable transmission rate, if so, goes back to step S312 to repeatedly perform the interactive transmission; otherwise, performs step S314 to check whether any other available communication connection, e.g. 3G connection, exists and if not, sequentially activates one of other communication connection, e.g. WIFI or blue-tooth connection.

Referring again to step S302, if no connection can be found (No in step S302), the communication module 108 performs step S314 to check whether a available 3G communication connection exists and if not, sequentially activates the WIFI communication connection and the blue-tooth communication connection. Then, step S302 is again performed by the communication module 108 to re-check whether any other connectable communication connection is presented until the multimedia device 200 has been successfully connected.

After the certificate verification module 202 of the multimedia device 200 received the authentication information from the portable device 100 via the established communication network, it may determine whether the authentication information is valid according to the connection information and the consumer behavior information included in the authentication information and if determined that the authentication information is valid, allows the portable device 100 to log in and establishes the communication network.

Upon successfully logging into the multimedia device 200, in step S206, the portable device 100 generates an operation user interface for operating the multimedia device 200 to select one of the multimedia information to be played. The multimedia information may be played on the multimedia device 200, and the multimedia information may also be played on the portable device 100. The portable device 100 may perform an interactive operation with the multimedia device 200 and operate the multimedia device 200 by an operation user interface to select one of the multimedia information to be played on the portable device 100 or the multimedia device 200 via the communication network. The multimedia device 200 may transmit an advertisement playing list related to the consumer behavior information to the portable device 100 via the established communication network for selection by the consumer, wherein the advertisement playing list includes a plurality of multimedia information and the portable device 100 may select one multimedia information from the advertisement playing list to be played via the operation user interface provided by an application. For example, the portable device 100 may first transmit the authentication information and a selection signal corresponding to the selected multimedia information to the multimedia device 200 via the communication module 108 and the certificate verification module 202 of the multimedia device 200 may then verify the received authentication information and transmit the selection signal to the media player 208. The media player 208 may then obtain multimedia information corresponding to the selection signal from the storage unit 210 and play it directly or transmit the obtained multimedia information by way of the video streaming transmission to the portable device 100.

The multimedia device 200 may further comprise a determination module for determining whether the multimedia device 200 is in an idle state. When the determination module determines that the multimedia device 200 is in the idle state, it generates an idle signal to the portable device 100 such that the portable device 100 generates the operation user interface to select one of the multimedia information to be played on the multimedia device 200, When the determination module determines that the multimedia device 200 is not in the idle state, it generates a non-idle signal to the portable device 100 such that the portable device 100 generates the operation user interface to select one of the multimedia information to be played on the portable device 100. In other words, the portable device 100 can select one of the multimedia information via the operation user interface and determine whether to play it on the multimedia device 200 or the portable device 100 according to the idle signal or the non-idle signal. In some embodiments, determination of whether the selected multimedia information is to be played on the multimedia device 200 or the portable device 100 may correspond to a user selection. That is, the consumer may self-determine that the selected multimedia information is to be played on the multimedia device 200 or the portable device 100. In some embodiments, the portable device 100 may automatically determine that the selected multimedia information is to be played on the multimedia device 200 when the multimedia device 200 is in the idle state. Contrarily, when determining that the multimedia device 200 is not in the idle state, i.e. the multimedia device 200 may currently be used by other consumers, the portable device 100 may determine that the selected multimedia information is to be played on the portable device 100.

In some embodiments, the steps of determining that the selected multimedia information is to be played on the portable device 100 may comprise sequentially receiving a plurality of video steaming information that correspond to the selected multimedia information and then sequentially playing the received video steaming information corresponding to the selected multimedia information on the portable device 100.

To be more specific, after video streaming connection is established with the multimedia device 200 and the portable device 100 through wireless connection, the multimedia device 200 starts to perform a Staggered-Channel-Cluster (SCC) transmission with the portable device 100 to selectively transmit the streaming data to the portable device 100 with Frame trimming/Frame rate adaptation mechanism or Segment-based opportunistic streaming mechanism. The portable device 100 receives the streaming data transmitted from the multimedia device 200, and after the received packet reassembled, playing the streaming data on the portable device 100. Wherein, the SCC transmission is a transmission with multiple channel and Interleaving, hence SCC is capable of patching packet loss that caused by burst error and jitter in. WLAN transmitting streaming, able to repair serious packet loss problem in multicast packet under radio interference environment, recovers jitter problem as multicast packet severed under radio interference environment, and enhances bandwidth efficiency at LAN end, thus effectively balancing transmission flow control. The Frame trimming/Frame rate adaptation mechanism means that while resource insufficient, adaptive measures can be adopted, by discarding relatively unimportant frame type like B frame. Generally speaking, advertisement information/multimedia information is a frame sequence composed of three different type of picture frames of a series of I(I-ntracoded), P(p-redicted), B(bi-directional), wherein the sequence can probably be: IBBBPBBBI . . . , and between two I-frame it is called Group of Picture (GOP). When I-frame can not be established for sure in the portable device 100 at the receiving end, the packet received but incapable of being rebuilt will be discarded. When it is ascertained that I-frame can not be established in the portable device 100 at the receiving end, the multimedia device 200 at the transmitting end will be notified that the remaining un-transmitted frames associated with missing group of pictures (GOP) are not needed to transmit. Segment-based opportunistic streaming mechanism is implemented by setting level of transmitting priority of frame types based on radio network signal quality thereby acquiring optimum transmission efficiency. Consequently, with above-mentioned streaming transmission technique, the multimedia device 200 can be able to transmit video streaming to the portable device 100 to perform the video streaming playing in real time.

When determining that the selected multimedia information is to be played on the multimedia device 200, the media player 208 obtains corresponding multimedia information from the storage unit 210 according to a selection signal from the portable device 100 and plays it on the multimedia device 200. When determining that the selected multimedia information is to be played on the portable device 100, the media player 104 receives and plays video streaming data from the multimedia device 200 on the portable device 100. Therefore, the selected multimedia information can be played on the multimedia device 200 or the portable device 100 respectively.

After completion of the playing of the selected multimedia information, in step S208, the multimedia device 200 transmits promotion information corresponding to the played multimedia information to the portable device 100. Meanwhile, the promotion information management module 204 may select suitable promotion information such as the coupon from the storage unit 210 according to the consumer behavior information, user information decoded by the certificate verification module 202 and media tag for the multimedia information selected by the portable device 100, and then transmit selected promotion information to the portable device 100 via the communication module 212.

Thereafter, in step S210, the portable device 100 receives promotion information corresponding to the selected multimedia information from the multimedia device 200 via the communication module 108. Therefore, the consumer may automatically obtain a corresponding promotion information of the selected multimedia information such as related coupon of movie ticket, store the obtained promotion information in the portable device 100 after the selected multimedia information is completely played and then print this coupon with a printing device for use in the specific place.

In some embodiments, the method for sending interactive promotion information of the invention may be implemented via an application installed on the portable device 100 and an application installed on the multimedia device 200. In this embodiment, it is first checked whether the portable device 100 has already installed application capable of connecting to and interacting with the multimedia device 200, if so, the application is activated; otherwise, it is directed to an application installing page to install such an application and then the installed application is further activated.

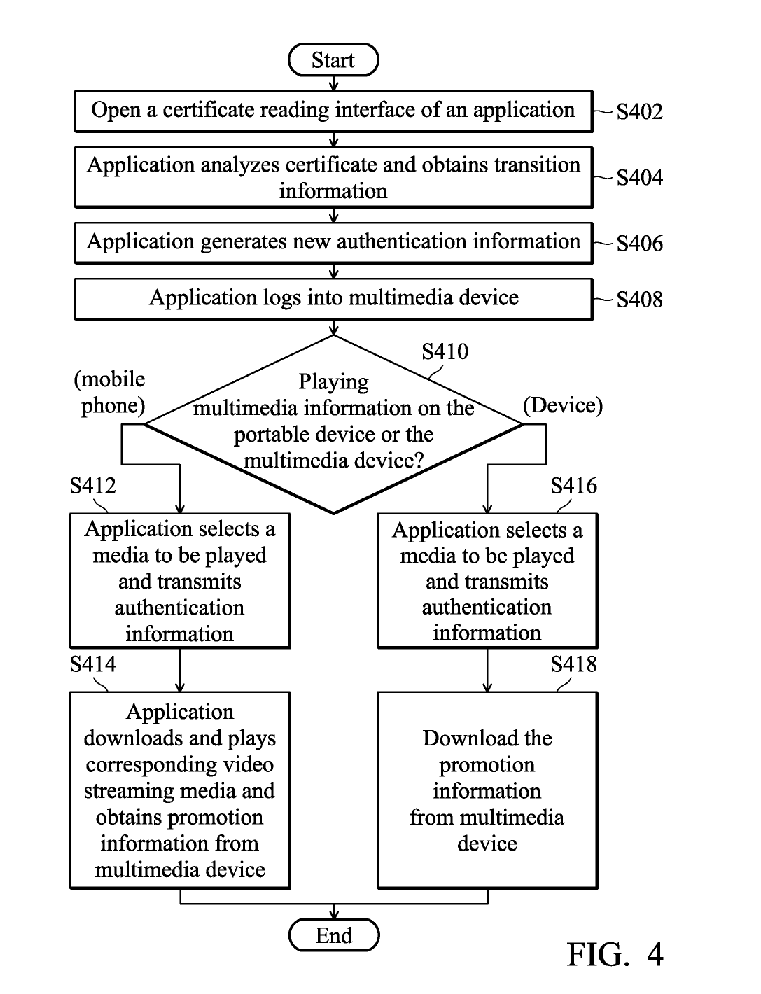

FIG. 4 is a flowchart of another embodiment of an operation flow for an application of the portable device of the invention. Please refer together to FIGS. 1B and 4. The method for sending interactive promotion information of the invention can be applied to the portable device 100. In step S402, a certificate reading interface of an application (hereinafter referred to as APP) is opened. In this embodiment, when the first certificate is a paper QR code, the certificate reading interface of the APP may include photographing and QR code analysis functionalities for the user to acquire a certificate image from the purchasing receipt using the photographing function and analysis the certificate image, by using the QR code analysis function, to obtain information included in the certificate image. Thereafter, in step S404, the APP analyzes the certificate and obtains information included in the certificate, including consumer behavior information and connection information containing, for example, an identification (ID) code, an IP address and a MAC address corresponding to the multimedia device 200. In step S406, the APP generates a new authentication information according to the consumer behavior information and related user information corresponding to the consumer. In step S408, the APP logs into the multimedia device 200 using the generated new authentication information. In step S410, the APP receives a selection for playing multimedia information on the portable device 100 or the multimedia device 200. When playing on the portable device 100 has been selected, in step S412, the APP provides an operation user interface to select a media to be played from the medias provided by the multimedia device 200 and transmits the authentication information and a selection signal including information regarding the selected media to be played to the multimedia device 200, and thus in step S414, downloads and plays the corresponding video streaming media and obtains promotion information, e.g. the coupon, from the multimedia device 200. When playing on the multimedia device 200 has been selected, in step S416, the APP provides an operation user interface to select a media to be played from the media provided by the multimedia device 200 and transmits the authentication information and a selection signal including information regarding the selected media to be played to the multimedia device 200. Thereafter, in step S418, the APP downloads the promotion information from the multimedia device 200.

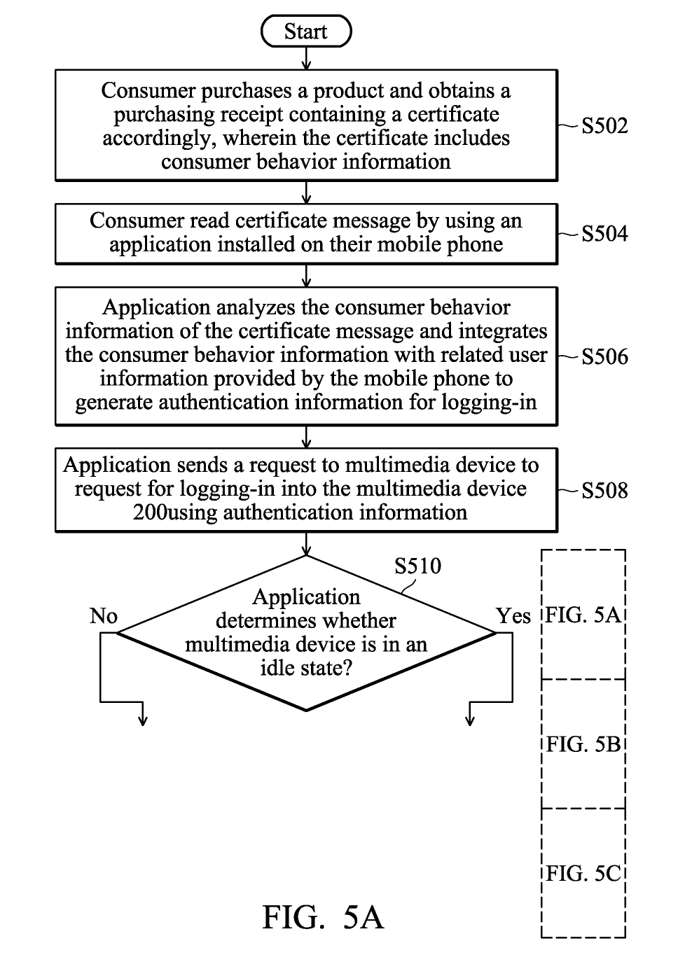

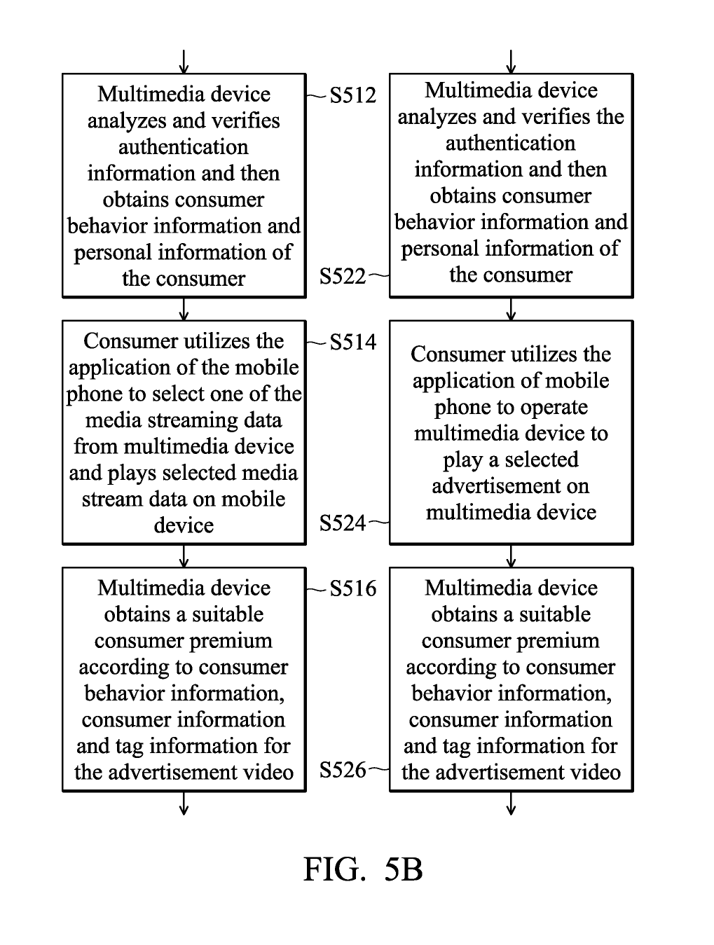

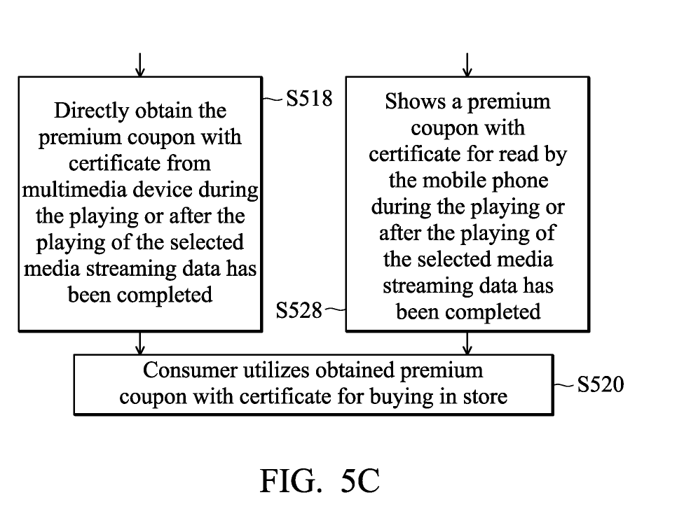

FIG. 5 is a flowchart of another embodiment of an operation flow for a method for sending interactive promotion information of the invention. Please refer together to FIGS. 1B and 5. The method for sending interactive promotion information can be applied to the system for sending interactive promotion information 10 for managing interactive information. In this embodiment, the portable device 100 can be a mobile phone and the multimedia device 200 is configured inside a business premise, e.g. a restaurant, a convenience store. First, in step S502, the consumer purchases a product and obtains a purchasing receipt containing a certificate accordingly. wherein the certificate includes consumer behavior information and connection information containing, for example, an identification (ID) code, an IP address and a MAC address corresponding to the multimedia device 200. In step S504, the consumer read the certificate message by using an application (APP) installed on their mobile phone. In step S506, the mobile phone analyzes the consumer behavior information of the certificate message through the APP and further integrates the consumer behavior information with related user information provided by the mobile phone, such as gender, age, education, profession and so on, to generate authentication information which can later be used for logging-in. In step S508, the mobile phone sends a request to the multimedia device 200 to request for logging into the multimedia device 200 using the authentication information through the APP. In step S510, the mobile device determines whether the multimedia device 200 is in an idle state through the APP. When determining that the multimedia device 200 is not in the idle state (No in step S510), in step S512, the multimedia device 200 analyzes and verifies the authentication information and then obtains the consumer behavior information and personal information of the consumer therefrom. In step S514, the consumer utilizes the APP of the mobile phone to select one of the media stream data from the multimedia device 200 and plays selected media stream data on the mobile device. In step S516, the multimedia device 200 obtains a suitable consumer premium according to the consumer behavior information, the consumer information and the tag information for the advertisement video. In step S518, during the playing or after the playing of the selected media streaming data has been completed, the mobile phone directly obtains the premium coupon with certificate from the multimedia device 200. Then, in step S520, the consumer utilizes the obtained premium coupon with certificate for buying in store.

Referring back to step S510, when determining that the multimedia device 200 is in the idle state (Yes in step S510), in step S522, the multimedia device 200 analyzes and verifies the authentication information and then obtains the consumer behavior information and personal information of the consumer therefrom. In step S524, the consumer utilizes the APP of the mobile phone to operate the multimedia device 200 to play a selected advertisement on the multimedia device 200. In step S526, the multimedia device 200 obtains a suitable consumer premium according to the consumer behavior information, the consumer information and the tag information for the advertisement video. In step S528, during the playing or after the playing of the selected media streaming data has been completed, the multimedia device 200 shows a premium coupon with certificate for read by the mobile phone. Then, in step S520, the mobile phone prints the obtained premium coupon with certificate such that the consumer can utilize the obtained premium coupon with certificate for buying in store.

In some embodiments, after the multimedia device 200 received the authentication information from the portable device 100, the multimedia device 200 may further acquire the consumer behavior information and related user information, such as gender, age, education, profession and so on, from the authentication information and by use of the consumer behavior information, the user information and a multimedia tag corresponding to the selected multimedia information, such as what kind of commodity advertisement selected, computation of mathematical statistics can be performed, to generate a sales forecasting analysis result. With this, wish list of consumers can be found, thus, helping the inventory management and improving advertisement substantial efficacy based on the sales forecasting analysis result.

Therefore, the methods for sending interactive promotion information and related systems of the invention allow users to use their portable device such as smart phone with applications program as operation user interface to interactive with multimedia devices/interactive panels configured in specific places, such as business premise of restaurant, convenience store, to perform an interactive operation, to select multimedia information which users really intend to brows, on the multimedia device or portable device to play, and obtain corresponding promotion information, e.g. coupons, thus, increasing fun for use and enhancing the using intension for the users. In addition, according to the method for sending interactive promotion information and related system of the invention, the free time of consumers in a specific place such as business premise of restaurant, convenience store, while waiting for commodity process, can be used for performing interaction such that in-store time for consumers can be increased, thereby consuming opportunity can be enhanced. Furthermore, the multimedia device in the specific place can further perform a computation of mathematical statistics to generate a forecasting and analysis for sales practices based on information provided by the user of the portable device, such as user information, consumer behavior information and information regarding corresponding selected multimedia tag, such as what kind of commodity advertisement was selected, such that real wish list of consumers can be found and, based on the sales forecasting analysis result, inventory management and advertisement substantial efficiency can be further enhanced, thereby, solving the biggest problem of the circulation industry and achieving the objective of precise marketing.

Methods for sending interactive promotion information, or certain aspects or portions thereof, may take the form of a program code (i.e., executable instructions) embodied in tangible media, such as floppy diskettes, CD-ROMS, hard drives, or any other non-transitory machine-readable storage medium, wherein, when the program code is loaded into and executed by a machine, such as a smart phone, a tablet computer, a laptop computer or other types of computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for sending interactive promotion information used between a portable device and a multimedia device, wherein the multimedia device is set in a specific place and stores a plurality of multimedia information and promotion information corresponding thereto, and the portable device is connected to the multimedia device through a communication network, the method comprising:
the portable device obtaining a first certificate corresponding to a product of the specific place, wherein the first certificate at least comprises consumer behavior information of the product and connection information for the multimedia device;
the portable device logging into the multimedia device through the first certificate and the communication network;
the portable device generating an operation user interface for operating the multimedia device to select one of the multimedia information to play after successfully logging into the multimedia device; and
after completion of playing the selected multimedia information, the multimedia device transmitting one of the promotion information corresponding to the selected multimedia information to the portable device.

2. The method of claim 1, wherein the multimedia information is played on one of the multimedia device and the portable device.

3. The method of claim 2, wherein the multimedia information comprises a video streaming signal and the portable device further comprises a multimedia player for playing the video streaming signal.

4. The method of claim 2, further comprising:
determining whether the multimedia device is in an idle state; and
generating an idle signal to the portable device and generating the operation user interface by the portable device and selecting the one of the multimedia information to be played on the multimedia device via the generated operation user interface when determining that the multimedia device is in the idle state.

5. The method of claim 4, further comprising:
generating an non-idle signal to the portable device and generating the operation user interface by the portable device and selecting the one of the multimedia information to be played on the portable device via the generated operation user interface when determining that the multimedia device is not in the idle state.

6. The method of claim 5, wherein a plurality of connections are provided between the multimedia device and the portable device, and the portable device further selects one connection from the connections to establish the communication network with the multimedia device according to a specific sequence.

7. The method of claim 1, wherein the first certificate further comprises a positioning information corresponding to the portable device to determine whether the portable device is located nearby the specific place within a predetermined range.

8. The method of claim 1, wherein the promotion information comprises coupon.

9. The method of claim 8, wherein the portable device further prints the coupon via a printing device for use the coupon in the specific place.

10. The method of claim 1, wherein the portable device further obtains the consumer behavior information and the user information from the authentication information and performs a computation of mathematical statistics to generate a forecasting and analysis for sales practices according to the consumer behavior information, the user information and a media tag corresponding to the selected multimedia information.

11. A system for sending interactive promotion information, comprising:
a multimedia device configured in a specific place, storing a plurality of multimedia information and promotion information corresponding thereto; and
a portable device connected to the multimedia device through a communication network, wherein the portable device obtains a first certificate corresponding to a product of the specific place, wherein the first certificate at least comprises consumer behavior information of the product and connection information for the multimedia device of the specific place to provide the portable device to log into the multimedia device through the communication network, and the portable device further generates an operation user interface for operating the multimedia device to select one of the multimedia information t o play after successfully logging into the multimedia device;
wherein the multimedia device further transmits one of the promotion information corresponding to the selected multimedia information to the portable device after completion of playing the selected multimedia information.

12. The system of claim 11, wherein the multimedia information is played on one of the multimedia device and the portable device.

13. The system of claim 12, wherein the multimedia information comprises a video streaming signal and the portable device further comprises a multimedia player for playing the video streaming signal.

14. The system of claim 11, wherein the portable device further comprises:
a communication module, establishing the communication network with the multimedia device for data transmission therebetween;
a storage unit, storing consumer behavior information, user information and the promotion information;
a certificate management module, receiving the first certificate, obtaining the consumer behavior information and the user information corresponding to the portable device from the first certificate an d generating an authentication information according to the consumer behavior information and the user information, wherein providing the portable device to log into the multimedia device through the communication network is achieved by the portable device logging into the multimedia device through the communication network according to the authentication information and the connection information.

15. The system of claim 11, wherein the multimedia device further comprises:
a communication module, establishing the communication network with the portable device for data transmission therebetween;
a verification module, receiving the first certificate and determining whether the portable device is allowed to successfully log into the multimedia device according to the first certificate;
a storage unit, storing the multimedia information and the promotion information corresponding thereto; and
a promotion information management module, determining a set of selectable multimedia information from the multimedia information stored in the storage unit according to the consumer behavior information, determining whether the playing of the selected multimedia information has been completed and transmitting the corresponding promotion information of the played multimedia information to the portable device after completion of playing the selected multimedia information; and
a media player, retrieving the selected multimedia information from the storage unit for playing in response to an selection signal generated by the operation user interface of the portable device.

16. The system of claim 11, wherein the first certificate further comprises a positioning information corresponding to the portable device and the multimedia device further comprises a device detection module for determining whether the portable device is located nearby the specific place within a predetermined range according to the positioning information.

17. The system of claim 11, wherein the multimedia device further comprises a determination module for determining whether the multimedia device is in an idle state and when determining that the multimedia device is in the idle state, generating an idle signal to the portable device such that the portable device generates the operation user interface and selects the one of the multimedia information to be played on the multimedia device via the generated operation user interface.

18. The system of claim 17, wherein when determining that the multimedia device is not in the idle state, the determination module further generates an non-idle signal to the portable device such that the portable device generates the operation user interface and selects the one of the multimedia information to be played on the portable device via the generated operation user interface.

19. The system of claim 18, wherein a plurality of connections are provided between the multimedia device and the portable device, and the portable device further selects one connection from the connections to establish the communication network with the multimedia device according to a specific sequence.

20. A non-transitory recording medium storing a computer program, which, when executed, causes a device to perform a method for sending interactive promotion information, and the method comprises:
obtaining a first certificate corresponding to a product of a specific place, wherein the first certificate at least comprises consumer behavior information of the product and connection information for a multimedia device configured on the specific place and the multimedia device stores a plurality of multimedia information and promotion information corresponding thereto;
generating authentication information according to the consumer behavior information and user information corresponding to the portable device contained in the first certificate;
logging into the multimedia device through a communication network according to the connection information and the authentication information;
operating the multimedia device by an operation user interface to select one of the multimedia information to be played on one of the multimedia device and the portable device after successfully logging into the multimedia device; and
receiving promotion information corresponding to the selected multimedia information from the multimedia device after completion of playing the selected multimedia information.
